(19) United States
(12) Patent Application Publication
(10) Pub. No.: US 2004/0207607 A1
(43) Pub. Date: Oct. 21, 2004

(54) Operating element having an integrated display element, and a method for command output using an operating element

(76) Inventors: Will Specks, Wolfsburg (DE); Heino Wengelnik, Wolfsburg (DE); Arne Stoschek, Palo Alto, CA (US)

Correspondence Address: KENYON & KENYON, ONE BROADWAY, NEW YORK, NY, 10004, US

(21) Appl. No.: 10/414,361

(22) Filed: Apr. 15, 2003

(51) Int. Cl. G09G 5/00

(52) U.S. Cl. 345/184; 345/157

(57) ABSTRACT

In an operating element, e.g., a rotatable operating element, a method for command output while using an operating element having at least one integrated display element and at least one operating function as well as uses of an operating element, the operating element has at least one integrated display element and at least one operating function, the at least one display element being freely programmable.

### FIELD OF THE INVENTION

The present invention relates to an operating element having an integrated display element and a method for command output using an operating element, as well as the arrangement of an operating element.

### BACKGROUND INFORMATION

Operating elements for triggering varied switching functions, control functions or regulating functions are generally conventional in a plurality of designs. In addition to the design as a rotary knob, use is also commonly made these days of rotary push buttons, double rotary knobs, double rotary push buttons, tumble switches, and rocker switches. The use of multifunctional operating elements has proven itself especially in the automotive field, based on the possibility of integrating varied operating functions into a single operating element and the improved safety in the vehicle guidance connected with it. Based on the multiplicity of controllable functions, freely selectable multifunctional operating elements are increasingly being used, especially in the last-mentioned field, which stand out by their great flexibility. In this context, the currently selected function is usually is made visual on an external multifunctional display unit. Such an operating device is described, for example, in European Published Patent Application No. 0 366 132.

The disadvantage of these multifunctional operating elements is that a mental association has to be made by the user, of data shown on a display unit to the respective operating element or to a special operating function of the operating element, the operating element and the display being made optically comprehensible. This turns out to be difficult, particularly during the guidance of a motor vehicle, and, even after some practice, it is encumbered with greater insecurity and time spent than in the comprehension of only one needed element.

Moreover, in the motor vehicle field, for reasons of safety, an attempt is made to position operating elements in the region of the steering wheel, whereby the difficulty arises of placing a multifunctional display, used for reasons of cost and based on the multiplicity of information, to be shown within the visual range of the driver, in the optimal position with respect to a plurality of operating elements. Furthermore, an unambiguous nature of the allocation of operating elements and display elements, when there is a plurality of operating elements simultaneously accessing a display unit, is difficult or impossible to achieve.

For this reason, it is described in German Published Patent Application No. 196 09 390 that one may allocate an individual display unit in the immediate vicinity of each multifunctional operating element, the current function of each respective operating element being made visual using the indicating device. The advantage of an unambiguous assignment is, in this instance, acquired at high costs and manufacturing expenditure. Moreover, data are shown on a multifunctional display unit, that are able to be influenced by the operating element, whereby, once again, the above-mentioned disadvantages are produced.

Therefore, it is also described in German Published Patent Application No. 199 29 973 that one may provide a rotatable operating element having a display unit positioned within the operating element, using which a setpoint value, for a fixed function, which is able to be set with the aid of the operating element, may be made visual. Hereby, to be sure, an unambiguous allocation of operation and display is achieved, but controllability of several functions is not fulfilled.

It is described in German Published Patent Application No. 199 41 616 that one may furnish a rotary knob, that may be axially shifted into three positions and has thereby three different functions placed on it, with a display device situated on its front, on which respective numerical data with respect to one of the selected functions are able to be shown. Here, too, the functions are fixed, and therefore a flexible use as multifunctional operating element is not possible.

It is an object of the present invention to provide an operating element which may avoid the disadvantages mentioned, by using greater flexibility in conjunction with an unambiguous allocation of status data.

### SUMMARY

The above and other beneficial objects of the present invention may be achieved by providing an operating element and a method as described herein.

This object may be attained by providing an operating element having an integrated display element which has the features described herein, as well as by providing a method for command output using an operating element having the features as described herein. The operating element according to the present invention may have at least one integrated display element as well as at least one operating function, the at least one display element being freely programmable. Because of the coupling being space-wise direct, on the one hand, an unambiguous allocation of display element and operating element may be achieved. Furthermore, any optical data may be shown in this manner, using the at least one display element, whereby a free selectability of the operating element for the most varied functions in connection with unambiguous allocability of the data may be achieved. This may yield a heightened operating convenience and greater safety in operating the operating element than was conventional up to this point, whereby the operating element may be suitable for multiple application possibilities, and may be particularly predestined to be used in safety-related areas. In addition to that, because of the arrangement of the present invention, an improved modularizability, space saving and an increase in the number of shared components used may be achieved.

In an example embodiment of the present invention, it may be provided that the operating element is arranged as a rotary knob, multiple rotary knob, rotary switch, multiple rotary switch, rotary push button, multiple rotary push button, tumble switch, rocker switch, etc. In this manner, multiple and ergonomically favorable application possibilities of the operating element may be achieved. In an arrangement as tumble switch or rocker switch, two or more switching states may be implementable, a rocker switch being rotatable about one or more axes.

In addition, in an example embodiment of the present invention, it may be provided that the at least one operating function is implementable by an axial shiftability of the operating element. It is also possible that the at least one operating function may be implementable by a shiftability of the operating element in at least one spatial direction in a plane arranged perpendicular to the axis of rotation of the operating element. An exceptionally great flexibility in operability may be achieved by these arrangements of the example embodiments of the present invention.

Moreover, in an example embodiment of the present invention, it may be provided that at least one signal may be able to be generated and output with the aid of the at least one operating function. This may yield multiple application possibilities of the operating element in, for instance, control technology, which stand out because of their especially favorable properties. It may also be provided that the at least one signal is a continuously variable signal and/or an incremental signal and/or an electrical signal. This may achieve a particularly favorable possibility of further processing of the signal generated by an operation of the operating element, for control purposes, for example.

Moreover, in an example embodiment of the present invention, it may be provided that the at least one display element includes at least one organic light-emitting diode (OLED) and/or at least one matrix made up of OLEDs and/or at least one light-emitting diode (LED) and/or at least one matrix made up of LEDs and/or at least one liquid crystal display (LCD). The use of the elements named may provide a minimalization of energy use as well as the required installation space, e.g., by the use of OLEDs, which may be arranged in very thin layers, the at least one display element and thus the operating element.

Furthermore, in an example embodiment of the present invention it may be provided that the at least one display element may be configured to be circular, annular, polygonal, etc. This manner may yield multiple configuration possibilities of the at least one display element, which may provide particularly favorable integration possibilities of the at least one display element and the capabilities of showing data. In this context, it may be provided that at least one display element may be arranged on the front of the operating element, and furthermore, in particular, that the at least one display element may be arranged at the surface area of the operating element, since thereby a particularly favorable displayability as well as readability of data may be achieved, depending on the particular case of application.

Beyond that, in an example embodiment of the present invention, it may be provided that the setting of the at least one display element may be changed using the at least one operating function. It may also be provided that the setting of the at least one display element may be maintained by an operation of the operating element. Depending on the application case, this may yield data sets of example to be displayed that may be easy to implement.

It may also be provided in an example embodiment of the present invention that at least one graphic object may be displayable using the at least one display element, the at least one graphic object being, e.g., alphanumeric, a graphic symbol, an image, etc. This may achieve an especially favorable possibility of displaying information as well as a particularly great presentation effect.

It may be provided in an example embodiment of the present invention that the at least one graphic object may be freely specified by a user. In this manner, multiple use possibilities may be achieved, which may provide particularly great flexibility. It may also be provided that the at least one graphic object may include a company logo, a corporate ID, etc., since thereby, particularly in the motor vehicle field, this may give especially great protection from wrongful purloining.

In an example embodiment of the present invention, it may also be provided that the at least one graphic object may be at least one element of a data set of at least one vector of graphic objects and/or of a matrix of graphic objects, the at least one element being selectable from the data set and/or being able to be activated, e.g., using the at least one operating function. In this manner, an operation that is particularly simple to handle and to learn may be achieved.

In an example embodiment of the present invention, it may be provided that the at least one graphic object may be able to be animated, the animation, e.g., including a change of color and/or of brightness and/or of size and/or of setting and/or of the setting of the at least one graphic object. This may yield multiple design possibilities of optical data sets of examples which may stand out by their especially favorable noticeability and comprehensibility. It may furthermore be provided that the animation may be triggered and/or influenced using the at least one operating function. In this manner, a reaction of the animation to an operation of the operating element may be implementable, whereby there comes about, e.g., an especially well noticeable optical feedback to the operation of the operating element.

Additionally, it may be provided in an example embodiment of the present invention that, using the at least one display element, a section of one graphic and/or a spatial arrangement of at least one graphic object may be able to be displayed, whose size exceeds the physical dimensions of the display area of the at least one display element, the setting and/or the size of the section may be able to be changed, e.g., using the at least one operating function. This may link an especially simply understandable and manageable operation with a minimization of the required installation space.

Furthermore, it may be provided in an example embodiment of the present invention that the operating element may include at least one control unit for controlling the at least one display element. In particular, it may be provided herewith that the rotary knob includes at least one storage device, the at least one graphic object, e.g., being storable in the at least one storage device and being selectable using the at least one operating function. In this manner, favorable integratability of the operating element may be achieved, while reducing the number of components required for the application. Consequently, for example, graphic object information is able to be pre-installed via data sets of alphanumeric symbols, so that only data sets of examples based on this data set and corresponding to the respective operating function and control function may have to be programmed.

In an example embodiment of the present invention, it may be provided that the at least one graphic object and/or the graphic may be able to be shown on at least one external display unit. This may yield an ability to broaden the noticeability of the at least one graphic object or the at least one graphic.

In an example embodiment of the present invention, it may be provided that the operating element may be able to be connected in an electrically conducting manner, using at least one connecting device, to at least one voltage supply and/or at least one external control unit. In this manner, there may be achieved a coupling ability with external electrical and/or electronic systems.

The method according to an example embodiment of the present invention for command output, while using an operating element having at least one integrated display element and at least one operating function, may provide that, using the at least one display element, at least one section of a graphic and/or a spatial arrangement from at least one graphic object is shown, with the aid of which at least one operating function of the at least one section is changed in its position and/or its size, using the at least one operating function the at least one section and/or an area of the at least one section is activated, and at least one signal corresponding to the activated at least one section or area of the at least one section is generated and emitted. From this there may result an improved operating convenience and greater safety in the operation of the operating element than was conventional. Furthermore, a minimizability of the required installation space may be achieved.

Within the framework of the method according to an example embodiment of the present invention, it may be provided that the at least one graphic object is alphanumeric, a graphic symbol, an image, etc. This may achieve an especially favorable possibility of displaying information as well as a particularly great presentation effect.

Within the framework of the method according to an example embodiment of the present invention, it may be provided that the at least one graphic object may be animated, the animation, e.g., including a change of color and/or of brightness and/or of size and/or of setting and/or of the position of the at least one graphic object, etc. This may yield multiple design possibilities of optical data sets of examples which may stand out by their especially favorable noticeability and comprehensibility. It may be provided that the animation is able to be triggered and/or is influenced, using the at least one operating function. In this manner, a reaction of the animation to an operation of the rotary knob may be implementable, whereby there may come about an especially well noticeable optical feedback to the operation of the operating element.

Furthermore, within the framework of the method according to an example embodiment of the present invention, it may be provided that, as the operating element, a rotary knob, multiple rotary knob, rotary switch, multiple rotary switch, rotary push button, multiple rotary push button, tumble switch, rocker switch, etc., may be used. In this manner, multiple and ergonomically favorable application possibilities of command output may be achieved. In an arrangement as tumble switch or rocker switch, two or more switching states may be implementable, a rocker switch being rotatable about one or more axes.

In addition, within the framework of the method according to an example embodiment of the present invention, it may be provided that the at least one operating function may be implementable by an axial shiftability of the operating element. It may be provided that the at least one operating function may be implemented by a shiftability of the operating element in at least one spatial direction in a plane arranged perpendicular to the axis of rotation of the operating element. An exceptionally great flexibility in operability may be achieved by these arrangements of example embodiments of the present invention.

Within the framework of an example embodiment of the method of the present invention, it may be provided that the position of the at least one display element may be changed using the at least one operating function. It may be provided that the position of the at least one display element may be maintained by an operation of the operating element. Depending on the application case, this may yield especially simply implementable data sets of example to be displayed.

Within the framework of an example embodiment of the method of the present invention, it may be provided that the at least one graphic object may be stored in at least one storage device, and may be selected using the at least one operating function. In this manner, an especially favorable integratability of the rotary knob may be achieved, while, e.g., reducing the number of components required for the application. Consequently, for example, graphic object information may be able to be pre-installed via data sets of alphanumeric symbols, so that only data sets of examples based on this data set and corresponding to the respective operating function and control function may have to be programmed.

Within the framework of an example embodiment of the method of the present invention, it may be provided that the at least one signal may be a continuously changeable and/or incremental signal. This may achieve a particularly favorable possibility of further processing of the signal generated by an operation of the operating element, for control purposes, for example.

Within the framework of an example embodiment of the method of the present invention, it may be provided that the at least one graphic object and/or the at least one graphic may be displayed on at least one external display unit. This may yield an ability to broaden the noticeability of the at least one graphic object or the graphic.

Within the framework of an example embodiment of the method of the present invention, it may be provided that the at least one display element may include at least one organic light-emitting diode (OLED) and/or at least one matrix made up of OLEDs and/or at least one light-emitting diode (LED) and/or at least one matrix made up of LEDs and/or at least one liquid crystal display (LCD), etc. By using the elements named, a particularly good noticeability of optical data sets of examples shown may be achieved, whereby an increased safety in the operation may be yielded.

An operating element according to an example embodiment of the present invention may be configured as an operating element for motor vehicles, airplanes, ships, etc., since in these fields multiple possibilities of use may come up, the ergonomic and safe operability of the operating element being of relevance.

In addition, an operating element according to an example embodiment of the present invention may be provided as the operating element for window lifters, child locks, illumination devices, air conditioning, audio devices, video devices, multifunctional displays, telephone installations, gear shift levers, sliding roofs, tilting sun roofs, solar roofs, vehicle seats, etc., because the operating element may be suitable for these application fields, based on its flexibility and ergonomics.

Further example embodiments of the present invention are set forth below.

The present invention is explained below in more detail with the reference to exemplary embodiments and the corresponding drawings.

### BRIEF DESCRIPTION OF THE DRAWINGS

FIG. 1 is a schematic view of an operating element having an integrated display element.

FIG. 2 is a schematic view of an operating element having a graphic object in operation which is illustrated on an integrated display element.

FIG. 3 is a schematic view of an operating element having an animated graphic object in operation which is illustrated on an integrated display element.

FIG. 4 is a schematic view of an operating element having an animated graphic object in operation which is illustrated on an integrated display element.

### DETAILED DESCRIPTION

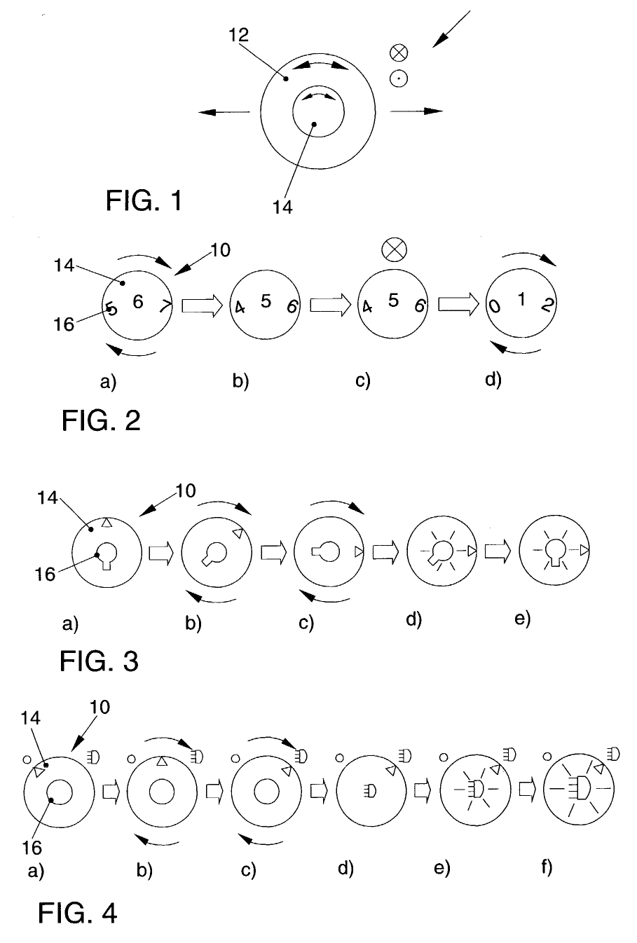

FIG. 1 illustrates schematically an example embodiment of an operating element 10 according to the present invention, in a front view. Operating element 10 is configured as a double rotary push button, and offers four operating functions, two operating functions being implemented by an inner and an outer rotatable operating part. An axial shiftability of operating element 10 forms a further operating function, which is indicated by two arrows, entering into the image plane and exiting from the image plane. The fourth operating function is given by a horizontal shiftability of operating element 10. Operating element 10 has two integrated and freely programmable display elements 12 and 14, of which one is configured to be circular (display element 14) and is positioned centrically on the front side of the inner operating part. Second display element 12 is configured to be annular and is placed on the front side of the outer operating part. Operating element 10 according to the present invention may offer a great measure of operating convenience, coupled with a clear allocation of the data shown on display elements 12 and 14 to the respective operating part of operating element 10, a great flexibility in the application being fulfilled by the free programmability of display elements 12 and 14.

FIG. 2 illustrates an example embodiment in operation of an operating element 10 according to the present invention, having an integrated, freely programmable display element 14. Operating element 10 is configured as a rotary push button. On display element 14, with the aid of the free programmability implemented, a section is illustrated from a spatial arrangement of a plurality of graphic objects 16 in the form of numerical symbols of a vector. By turning operating element 10, the setting of the section is variable, so that further symbols appear in the section and become visible, others move out of the section and thus disappear from the visible range. This is illustrated by operating states a) and b). Using a rotation of operating element 10 in the sense of a clock's hand, the window is moved virtually to the left, or rather, the arrangement of symbols is moved virtually to the right, so that the numeral “5” which is to the left of the “6” in a) moves into operating state b), into the middle position of numeral “6” in a), and is thus selected. In operating state c), numeral “5” is now activated by pressure on the rotary push button, a signal corresponding to numeral “5”, for example, being able to be output in order to trigger an external control procedure. In operating state d), operating element 10 is rotated further clockwise, until numeral “1” of the vector appears in the middle, and is thus able to be activated. By the use of operating element 10 according to the present invention, an especially simply understandable and manageable operation, linked with a minimization of the required installation space, may be achieved.

FIG. 3 illustrates an operating element 10 configured as a rotary knob in operation, having an animated graphic object 16 illustrated on an integrated freely programmable display element 14. Operating element 10 is rotated from the 12 o'clock position in operating state a), via operating state b), to the 3 o'clock position in operating state c). This movement is carried out analogously by graphic object 16 arranged in the shape of a light bulb. While operating element 10 remains in the 3 o'clock position, graphic object 16 is animated, as illustrated in operating state d). In this connection, a counterclockwise rotation of the light bulb may be carried out, the brightness of the light bulb being simultaneously increased. The light bulb is further rotated up to the 12 o'clock position in operating state e) while the brightness is further increased. Operating element 10 may be distinguished by its great operating convenience, a particularly favorable noticeability and comprehensibility of the data output on display element 14, and thus of the operating state, being achieved by the arrangement according to the present invention.

FIG. 4 illustrates another example embodiment of an operating element 10 in operation, having an animated graphic object 16 illustrated on an integrated freely programmable display element 14. Operating element 10 configured as a rotary knob is rotated from the 11 o'clock position in operating state a), via operating state b), to the 1 o'clock position in operating state c). In this case, a graphic object 16 is illustrated in the form of a circle on display element 14. While operating element 10 remains in the 1 o'clock position, a graphic object 16 is illustrated in the form of a schematic headlight, its size and brightness being enlarged or increased as animation via operating state e) up to operating state f) Operating element 10 may be distinguished by its great operating convenience, a particularly favorable noticeability and comprehensibility of the data output on display element 14, and thus of the operating state, being achieved by the arrangement according to the present invention.

### Reference Numeral List

10 operating element

12 display element, annular

14 display element, circular

16 graphic object

What is claimed is:

1. An operating element, comprising:
at least one integrated, freely programmable display element; and
an arrangement configured to provide at least one operating function.

2. The operating element according to claim 1, wherein the operating element is configured as a rotatable operating element.

3. The operating element according to claim 1, wherein the operating element is configured as at least one of a rotary knob, a multiple rotary knob, a rotary switch, a multiple rotary switch, a rotary push button, a multiple rotary push button, a tumble switch and a rocker switch.

4. The operating element according to claim 1, wherein the arrangement is configured to provide the at least one operating function in accordance with axial shiftability of the operating element.

5. The operating element according to claim 1, wherein the arrangement is configured to provide the at least one operating function in accordance with shiftability of the operating element in at least one spatial direction in a plane perpendicular to an axis of symmetry of the operating element.

6. The operating element according to claim 1, further comprising an arrangement configured to generate and output at least one signal in accordance with the at least one operating function.

7. The operating element according to claim 6, wherein the at least one signal includes at least one of a continuously variable signal, an incremental signal and an electrical signal.

8. The operating element according to claim 1, wherein the at least one display element includes at least one of at least one organic light-emitting diode, at least one matrix of organic light-emitting diodes, at least one light-emitting diode, at least one matrix of light-emitting diodes and at least one liquid crystal display.

9. The operating element according to claim 1, wherein the at least one display element is arranged at least one of circular, annular and polygonal.

10. The operating element according to claim 1, wherein the at least one display element is arranged on a front of the operating element.

11. The operating element according to claim 1, wherein the at least one display element is arranged on a surface area of the operating element.

12. The operating element according to claim 1, wherein a position of the at least one display element is variable in accordance with the at least one operating function.

13. The operating element according to claim 1, wherein the at least one display element is configured to maintain a position during operation of the operating element.

14. The operating element according to claim 1, wherein the at least one display element is configured to display at least one graphic object.

15. The operating element according to claim 14, wherein the at least one graphic object includes at least one of an alphanumeric object, a graphic symbol and an image.

16. The operating element according to claim 14, wherein the at least one graphic object is freely specifiable by a user.

17. The operating element according to claim 14, wherein the at least one graphic object includes at least one of a company logo and a corporate identification.

18. The operating element according to claim 14, wherein the at least one graphic object includes at least one element from a data set of at least one of at least one vector of graphic objects and at least one matrix of graphic objects.

19. The operating element according to claim 18, further comprising an arrangement configured to at least one of select the at least one element from the data set and to activate the at least one element in accordance with the at least one operating function.

20. The operating element according to claim 14, wherein the at least one graphic object is animatable.

21. The operating element according to claim 20, wherein an animation of the at least one graphic object includes a change of at least one of a color, a brightness, a size, a setting and a position of the at least one graphic object.

22. The operating element according to claim 20, further comprising an arrangement configured to at least one of trigger and influence an animation of the at least one graphic object in accordance with the at least one operating function.

23. The operating element according to claim 1, wherein the at least one display element is configured to display a section of at least one of a graphic and a spatial arrangement of at least one graphic object, wherein a size of the at least one of the graphic and the spatial arrangement of the at least one graphic object exceeds a physical dimension of a display area of the at least one display element.

24. The operating element according to claim 23, further comprising an arrangement configured to change at least one of a position and a size of the section in accordance with the at least one operating function.

25. The operating element according to claim 1, further comprising at least one control unit configured to control the at least one display element.

26. The operating element according to claim 1, further comprising at least one storage medium.

27. The operating element according to claim 26, wherein the at least one storage medium is configured to store the at least one graphic object, the operating element further comprising an arrangement configured to select the at least one graphic object in accordance with the at least one operating function.

28. The operating element according to claim 1, further comprising at least one external display unit configured to display at least one of at least one graphic object and a graphic.

29. The operating element according to claim 1, further comprising at least one connection configured to electrically conductively connect to at least one of at least one voltage supply and at least one external control unit.

30. The operating element according to claim 29, further comprising an arrangement configured to at least one of generate and output at least one signal in accordance with the at least one operating function via the at least one connection device.

31. The operating element according to claim 1, wherein the operating element is arranged as an operating element in at least one of a motor vehicle, an airplane, a ship, a window lifter, a child lock, an illumination device, an air conditioner, an audio device, a video device, a multifunction display, a telephone installation, a gear shift lever, a sliding roof, a tilting sunroof, a solar roof and a vehicle seat.

32. A method for command output in accordance with an operating element including at least one integrated display element and an arrangement configured to provide at least one operating function, comprising:
displaying at least one section of at least one of a graphic and a spatial arrangement of at least one graphic object on the at least one display element;
changing at least one of a size and a position of the at least one section in accordance with the at least one operating function;
activating at least one of the at least one section and an area of the at least one section in accordance with the at least one operating function; and
generating and outputting at least one signal corresponding to the activated at least one of the at least one section and the area of the at least one section.

33. The method according to claim 32, wherein the at least one graphic object includes at least one of an alphanumeric object, a graphic symbol and an image.

34. The method according to claim 32, further comprising animating the at least one graphic object.

35. The method according to claim 34, wherein the animating includes changing at least one of a color, a brightness, a size, a setting and a position of the at least one graphic object.

36. The method according to claim 34, further comprising at least one of triggering and influencing the animation in accordance with the at least one operating function.

37. The method according to claim 32, wherein the operating element includes at least one of a rotary knob, a multiple rotary knob, a rotary switch, a multiple rotary switch, a rotary push button, a multiple rotary push button, a tumble switch and a rocker switch.

38. The method according to claim 32, further comprising implementing the at least one operating function by axial shifting of the operating element.

39. The method according to claim 32, further comprising implementing the at least one operating function by shifting the operating element in at least one spatial direction in a plane perpendicular to an axis of symmetry of the operating element.

40. The method according to claim 32, further comprising changing a position of the at least one display element in accordance with the at least one operating function.

41. The method according to claim 32, further comprising maintaining an aspect of the at least one display element during operation of the operating element.

42. The method according to claim 32, further comprising storing the at least one graphic object in at least one storage medium and selecting the at least one graphic object in accordance with the at least one operating function.

43. The method according to claim 32, wherein the at least one signal includes at least one of a continuously variable signal and an incremental signal.

44. The method according to claim 32, further comprising displaying at least one of the at least one graphic object and the at least one graphic on at least one external display unit.

45. The method according to claim 32, wherein the at least one display element includes at least one of at least one organic light-emitting diode, at least one matrix of organic light-emitting diodes, at least one light-emitting diode, at least one matrix of light-emitting diodes and at least one liquid crystal display.
